(19) United States
(12) Patent Application Publication
(10) Pub. No.: US 2022/0375007 A1
(43) Pub. Date: Nov. 24, 2022

(54) METHOD FOR CALCULATING GRADING AND STAGED DROUGHT LIMITED STORAGE CAPACITY OF CASCADE RESERVOIRS

(71) Applicant: China Institute of Water Resources and Hydropower Research, Beijing (CN)

(72) Inventors: Ziqi YAN, Beijing (CN); Jinli ZHENG, Beijing (CN); Zuhao ZHOU, Beijing (CN); Denghua YAN, Beijing (CN); Yangwen JIA, Beijing (CN); Hao WANG, Beijing (CN); Jiajia LIU, Beijing (CN)

(73) Assignee: China Institute of Water Resources and Hydropower Research, Beijing (CN)

(21) Appl. No.: 17/747,883

(22) Filed: May 18, 2022

(30) Foreign Application Priority Data
May 20, 2021 (CN) 202110551122.X

(51) Int. Cl. G06Q 50/06; G06Q 50/02; G06Q 10/06; G06F 17/18

(52) U.S. Cl. CPC G06Q 50/06; G06Q 50/02; G06Q 10/06393; G06F 17/18

(57) ABSTRACT

Disclosed is a method for calculating grading and staged drought limited storage capacity of cascade reservoirs in different stages of drought, including: obtaining a characteristic storage capacity of an aggregated reservoir after aggregation and generalization according to a characteristic storage capacity of single reservoirs; determining a stage of drought early warning of the aggregated reservoir; calculating the water inflow of the aggregated reservoir after aggregation and generalization by superposition according to the water inflow of the single reservoirs; calculating a design water supply of the aggregated and generalized reservoir by superimposing the design water supply of single reservoirs; grading drought limited storage capacities into a drought warning storage capacity and a drought guaranteed storage capacity, and setting water supply coefficients for the graded drought limited storage capacities to realize drought early warning and water supply limit; and comprehensively calculating the drought limited storage capacities of the aggregated and generalized reservoir as drought limited storage capacity of the cascade reservoirs.

### CROSS-REFERENCE TO RELATED APPLICATIONS

This application claims priority to Chinese Patent Application No. 202110551122.X, filed on May 20, 2021, the contents of which are hereby incorporated by reference.

### TECHNICAL FIELD

The present disclosure relates to the technical field of drought-resistant dispatching of reservoirs, and in particular to a method for calculating grading and staged drought limited storage capacity of cascade reservoirs.

### BACKGROUND

Drought is a main natural disaster in China, and possibilities of drought are increasing day by day. Drought has long been a problem in disaster control in China. With the rapid increase of social and economic distribution density, the losses caused by the same level of drought have increased significantly. There are new challenges in drought control. Drought control has long been lacking of key indicators for drought identification. The uncertainty of the occurrence process of drought has made the drought early warning be an insurmountable obstacle for a long time. However, as the meteorological and hydrological monitoring stations are continuously improved and the forecasting accuracy of meteorological and hydrological models are improved, the lack of scientific and effective drought early warning indicators has become a new obstacle to drought control.

Reservoirs, as a water conservancy engineering structure that blocks flood, stores water and regulates water flow, play a very important role in regional flood control and drought relief. At present, the research on the key control storage capacity of reservoir drought resistance is not mature, and the research achievements are less than that of the flood limited storage capacity. Reservoir group drought control plays an important role in regional drought resistance, and an establishment of cascade reservoir group drought limited storage capacity is of great significance to reservoir drought control.

### SUMMARY

An objective of the present disclosure is to provide method for calculating grading and staged drought limited storage capacity of cascade reservoirs, so as to solve the aforementioned problems existing in the prior art.

In order to achieve the above objective, a technical scheme adopted by the present disclosure is as follows:

a method for calculating grading and staged drought limited storage capacity of cascade reservoirs, including following steps:

S1: analyzing a characteristic storage capacity of multiple single reservoirs, and aggregating and generalizing cascade reservoirs based on multiple reservoirs in series to obtain a characteristic storage capacity of an aggregated and generalized reservoir;

S2: determining stages of drought early warning of the aggregated reservoir according to the basin precipitation, runoff, user demand and reservoir regulation and storage;

S3: analyzing a water inflow of the single reservoirs, and calculating the water inflow of the aggregated and generalized reservoir by superimposing the water inflow of the single reservoirs;

S4: analyzing a water supply guarantee target of the aggregated reservoir, and calculating a design water supply of the aggregated reservoir by superimposing the design water supply of the single reservoirs;

S5: grading a drought limited storage capacity into two levels according to actual drought early warning demand, a drought warning storage capacity and a drought guaranteed storage capacity, and setting water supply coefficients for the graded drought limited storage capacities to realize drought early warning and water supply limit of different levels; and

S6: comprehensively calculating the drought limited storage capacities of the aggregated reservoir as drought limited storage capacity of the cascade reservoirs, based on a reservoir dispatching technology of recursion in a reverse order;

Optionally, S1 specifically refers to obtaining the characteristic storage capacity information of every reservoir based on the investigated and collected dispatching data of multiple reservoirs, and then aggregating and generalizing the cascade reservoirs in series by using the characteristic storage capacity superposition method of single reservoirs, to obtain the characteristic storage capacity of the aggregated reservoir; the calculation formulae are

Z_{D}=Σⱼ₌₁ⁿZ′_{Dj},

Z_{L}=Σⱼ₌₁ⁿZ′_{Lj},

Z_{N}=Σⱼ₌₁ⁿZ′_{Nj},

where Z′_{Dj} is a dead storage capacity of the j^{th} reservoir, Z′_{Lj} is a flood limited storage capacity of the j^{th} reservoir, Z′_{Nj} is a beneficial storage capacity of the j^{th} reservoir and Z_{D}, Z_{L} and Z_{N} are a dead storage capacity, a flood limited storage capacity and a beneficial storage capacity of the aggregated reservoir respectively.

Optionally, S2 specifically refers to determining the stages of drought early warning of the aggregated reservoir according to the basin precipitation, runoff, user demand and reservoir regulation and storage, and generally dividing the stages of drought early warning the aggregated reservoir into flood seasons, non-flood seasons and agricultural irrigation seasons.

Optionally, S3 specifically refers to respectively superposing a monthly inflow of single reservoirs in general low-flow years and extraordinary low-flow years to obtain the monthly inflow of the aggregated reservoir in the general low-flow years and the extraordinary low-flow year; the calculation formulae are

Dᵢ=ρⱼ₌₁ⁿQⱼᵢ,

D′ᵢ=ρⱼ₌₁ⁿQ′ⱼᵢ,

where Qⱼᵢ is the inflow water of the j^{th} reservoir in i^{th} month in the general low-flow years, Q′ⱼᵢ is the inflow water of the j^{th} reservoir in i^{th} month in the extraordinary low-flow year, Dᵢ is the inflow water of the aggregated reservoir in i^{th} month in the general low-flow years; D′ᵢ is the inflow of the aggregated reservoir in i^{th} month in the extraordinary low-flow years.

Optionally, S4 specifically includes following content:

calculating the design water supply of the aggregated reservoir by superimposing the design water supply of the single reservoirs according to following formula:

W_{T}=Σⱼ₌₁ⁿ{W_{s,j}+W_{g,j}+W_{ir,j}},

where W_{T} is the design water supply of aggregated cascade reservoir, and W_{s,j}, W_{g,j}, W_{ir,j} are a domestic design water supply, an industrial design water supply and an agricultural design water supply of the j^{th} reservoir in t^{th} month.

Optionally, S5 specifically refers to, aiming at a drought limited storage capacity of the aggregated reservoir, limiting the water supply to the industries by setting different water supply guarantee coefficients, so as to achieve drought early warning of different levels; calculation formulae are:

Wₜ=Σⱼ₌₁ⁿ{W_{s,j}+W_{g,j}+a×W_{ir,j}},

Wₜ′=Σⱼ₌₁ⁿ{W_{s,j}+b×W_{g,j}+a×W_{ir,j}}.

where Wₜ is the water supply of the aggregated reservoir after the level-I supply limit of the early warning object in t^{th} month, Wₜ′ is the water supply of the aggregated reservoir after level-II supply limit of the early warning object in t^{th} month, a and b are adjustment coefficients respectively, a represents a ratio of a minimum agricultural water consumption to the design water supply, and b represents a ratio of a minimum industrial water consumption to the design water supply.

Optionally, S6 specifically refers to taking the inflow runoff quantity in design low-flow years and a process of guaranteeing water supply in different stages as inputs, assuming that the water quantity at the end of water supply season just reaches the dead storage capacity of the reservoir, out of consideration of continuous drought process, and obtaining the water quantity at the beginning of each month under different drought levels of the aggregated reservoir by means of recursion in reverse order according to a regulation principle of reservoir benefit; selecting the highest water quantity at the beginning of each month in each stage as the drought warning storage capacity or drought guaranteed storage capacity in each stage, a drought warning storage capacity or drought guaranteed storage capacity of the cascade reservoirs and then calculating the drought warning storage capacity and drought guaranteed storage capacity in each month as follows,

Zₜ=Wₜ+W_{loss,t}−Dₜ+Zₜ₊₁,

Z′ₜ=W′ₜ+W_{loss,t}−D′ₜ+Z′ₜ₊₁,

Z^{T+1}=Z_{D},

where Zₜ and Z′ₜ are respectively the drought warning capacity and drought guaranteed capacity of the aggregated reservoir in t^{th} month, Zₜ₊₁ and Z′ₜ₊₁ are respectively the drought warning storage capacity and drought guaranteed storage capacity in (t+1)^{th} month, W_{loss, t} is the amount of water lost by evaporation and leakage of the reservoir in t^{th} month, Dₜ is the inflow of reservoir in t^{th} month in general low-flow years, D′ₜ is the inflow of the reservoir in t^{th} month in the extraordinary low-flow year and Z^{T+1} is the water quantity at the end of design low-flow years; Wₜ is the water supply of reservoir in t^{th} month in general low-flow years; W′ₜ is the water supply of the reservoir in t^{th} month in the extraordinary low-flow years.

Optionally, the drought warning storage capacity and drought guaranteed storage capacity in each month should meet corresponding constraints, which are

$$\{ \begin{matrix}flood season : {Z}_{D} \leq {Z}_{t} \leq {Z}_{L} , {Z}_{D} \leq {Z}_{t}^{′} \leq {Z}_{L} \\ non - flood season : {Z}_{D} \leq {Z}_{t} \leq {Z}_{N} , {Z}_{D} \leq {Z}_{t}^{′} \leq {Z}_{N}\end{matrix} , \\ {Z}_{t} \geq {Z}_{t}^{′} ,$$

where Z_{D} is the dead storage capacity of the aggregated reservoir, Z_{L} is the flood limited storage capacity of the aggregated reservoir and Z_{N} is the beneficial water storage capacity of the aggregated reservoir.

The beneficial effects of the present disclosure are as follows: after the water supply guarantee target of cascade reservoirs is integrated, the inflow water of single reservoirs in general low-flow years and extraordinary low-flow years is accumulated, and the drought-resistant index of the drought limited storage capacity of the aggregated reservoir is obtained by the reverse time series recursive method, which provides direct support for scientific and orderly development of drought-resistant early warning work. Therefore, the drought limited storage capacity of typical cascade reservoirs in China is determined by zoning, classifying and grading, so as to meet the guarantee demand of drought-resistant water sources and provide reference for the optimal dispatching of water conservancy projects. The cascade reservoirs can be generalized into the aggregated reservoir according to the operation principle of the reservoir group, and the water supply demand and guarantee level of each user of the aggregated reservoir can be determined. At the same time, combined with the priority and guarantee rate of production, domestic, and ecological water demand in drought period, the determination method for classifying, staging and grading drought limited storage capacity index is studied, and the drought limited storage capacity is formulated according to the characteristics of different regions, which provides scientific basis and technical support for drought control command and decision-making.

### BRIEF DESCRIPTION OF THE DRAWINGS

FIG. 1 is a flowchart of a method for calculating grading and staged drought limited storage capacity of cascade reservoirs in an embodiment of the present application.

FIG. 2 is a schematic diagram of graded drought limit water level of reservoirs in different periods in an embodiment of the present application.

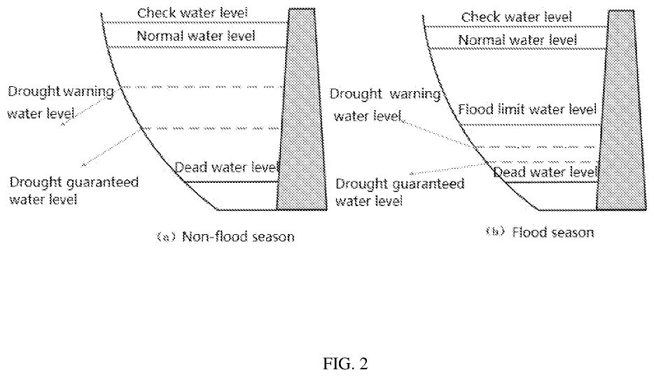

### DETAILED DESCRIPTION OF THE EMBODIMENTS

In order to make the objective, technical scheme and advantages of the present disclosure clearer, the present disclosure will be further explained in detail below with reference to the attached drawings. It should be understood that the specific embodiments described here are only for explaining the present disclosure, but not for limiting the present disclosure.

### Embodiment 1

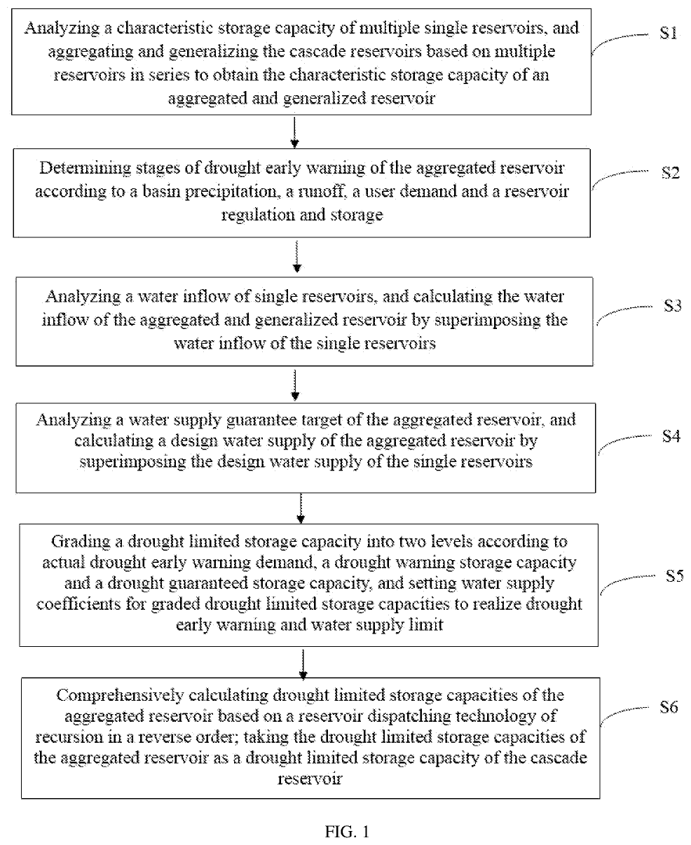

As shown in FIG. 1, in this embodiment, a method for calculating grading and staged drought limited storage capacity of cascade reservoirs provided includes the following steps:

S1: analyzing a characteristic storage capacity of multiple single reservoirs, and aggregating and generalizing the cascade reservoirs based on multiple reservoirs in series to obtain the characteristic storage capacity of an aggregated and generalized reservoir;

S2: determining stages of drought early warning of the aggregated reservoir according to the basin precipitation, runoff, user demand and reservoir regulation and storage;

S3: analyzing a water inflow of the single reservoirs, and calculating the water inflow of the aggregated and generalized reservoir by superimposing the water inflow of the single reservoirs;

S4: analyzing a water supply guarantee target of the aggregated reservoir, and calculating a design water supply of the aggregated reservoir by superimposing the design water supply of the single reservoirs;

S5: grading a drought limited storage capacity into two levels according to actual drought early warning demand, a drought warning storage capacity and a drought guaranteed storage capacity, and setting water supply coefficients for the graded drought limited storage capacities to realize drought early warning and water supply limit; and

S6: comprehensively calculating the drought limited storage capacities of the aggregated reservoir as drought limited storage capacity of the cascade reservoirs, based on a reservoir dispatching technology of recursion in a reverse order;

In this embodiment, the calculation method provided by the present disclosure mainly includes six parts, namely, obtaining the characteristic storage capacity of the aggregated and generalized reservoir, determining the stages of drought early warning of the aggregated reservoir, calculating the water inflow of the aggregated and generalized reservoir, calculating the design water supply of the aggregated reservoir, setting guarantee coefficients for the graded drought limit storage capacities to limit water supply, and calculating the drought limited storage capacity of the aggregated reservoir. The following elaborates the above six parts.

I. Obtaining the characteristic storage capacity of the aggregated and generalized reservoir

The content of this part is S1. Specifically, S1 refers to obtaining the characteristic storage capacity information of every reservoir based on the investigated and collected dispatching data of multiple reservoirs, and then aggregating and generalizing the cascade reservoirs in series by using a characteristic storage capacity superposition method of single reservoirs, to obtain the characteristic storage capacity of the aggregated reservoir; calculation formulae are:

Z_{D}=Σⱼ₌₁ⁿZ′_{Dj},

Z_{L}=Σⱼ₌₁ⁿZ′_{Lj},

Z_{N}=Σⱼ₌₁ⁿZ′_{Nj},

where Z′_{Dj} is a dead storage capacity of the j^{th} reservoir, in unit of m³, Z′_{Lj} is a flood limited storage capacity of the j^{th} reservoir, in unit of m³, Z′_{Nj} is a beneficial storage capacity of the j^{th} reservoir, and Z_{D}, Z_{L} and Z_{N} are a dead storage capacity (m³), a flood limited storage capacity (m³) and a beneficial storage capacity (m³) of the aggregated reservoir respectively.

II. Determining the stages of drought early warning of the aggregated reservoir

This part corresponds to S2. S2 specifically refers to determining the stages of drought early warning of the aggregated reservoir according to the basin precipitation, runoff, user demand and reservoir regulation and storage, and generally dividing the stages of drought early warning the aggregated reservoir into flood seasons, non-flood seasons and agricultural irrigation seasons.

III. Calculating the water inflow of the aggregated and generalized reservoir

This part corresponds to S3. S3 specifically refers to respectively superposing a monthly inflow of the single reservoirs in general low-flow years and extraordinary low-flow years to obtain the monthly inflow of the aggregated reservoir in the general low-flow years and the extraordinary low-flow years; the calculation formulae are

Dᵢ=Σⱼ₌₁ⁿQⱼᵢ,

D′ᵢ=Σⱼ₌₁ⁿQ′ⱼᵢ,

where Qⱼᵢ is the inflow water of the j^{th} reservoir in i^{th} month in the general low-flow years, in unit of m³, Q′ⱼᵢ is the inflow water of the j^{th} reservoir in i^{th} month in the extraordinary low-flow year, in unit of m³, Dᵢ is the inflow water of the aggregated reservoir in i^{th} month in the general low-flow years, in unit of m³, and D′ᵢ is the inflow of the aggregated reservoir in i^{th} month in the extraordinary low-flow years, in unit of m³.

Among them, the years with an inflow water frequency of 75% are selected as the general low-flow years and the years with the inflow frequency of 95% as the extraordinary low-flow years.

IV. Calculating the design water supply of the aggregated reservoir superimposing the design water supply of the single reservoirs according to following formula:

W_{T}=Σⱼ₌₁ⁿ{W_{s,j}+W_{g,j}+W_{ir,j}},

where W_{T} is the design water supply of the aggregated cascade reservoir, in unit of m³, and W_{s,j}, W_{g,j}, W_{ir,j} are the domestic design water supply (m³), industrial design water supply (m³) and agricultural design water supply (m³) of the j^{th} reservoir in t^{th} month;

V. Setting guarantee coefficients for the graded drought limit storage capacities to limit water supply

This part corresponds to S5. S5 specifically refers to, aiming at a drought limited storage capacity of the aggregated reservoir, limiting the water supply to the industries by setting different water supply guarantee coefficients, so as to achieve drought early warning of different levels; the calculation formulae are

Wₜ=Σⱼ₌₁ⁿ{W_{s,j}+W_{g,j}+a×W_{ir,j}},

Wₜ′=Σⱼ₌₁ⁿ{W_{s,j}+b×W_{g,j}+a×W_{ir,j}}.

where Wₜ is the water supply of the aggregated reservoir after the level-I supply limit of the early warning object in t^{th} month, Wₜ′ is the water supply of the aggregated reservoir after level-II supply limit of the early warning object in t^{th} month, a represents a ratio of a minimum agricultural water consumption to the design water supply, and b represents a ratio of a minimum industrial water consumption to the design water supply.

VI. Calculating the drought limited storage capacity of the aggregated reservoir

This part corresponds to S6. S6 specifically refers to taking the inflow runoff quantity in design low-flow years and a process of guaranteeing water supply in different levels as inputs, assuming that the water quantity at the end of water supply season just reaches the dead storage capacity of the reservoir, out of consideration of continuous drought process, and obtaining the water quantity at the beginning of each month under different drought levels of the aggregated reservoir by means of recursion in reverse order according to a regulation principle of reservoir benefit; selecting the highest water quantity at the beginning of each month in each stage as the drought warning storage capacity or drought guaranteed storage capacity in each stage, drought warning storage capacity or drought guaranteed storage capacity of the cascade reservoirs and then calculating the drought warning storage capacity and drought guaranteed storage capacity in each month as follows,

Zₜ=Wₜ+W_{loss,t}−Dₜ+Zₜ₊₁,

Z′ₜ=W′ₜ+W_{loss,t}−D′ₜ+Z′ₜ₊₁,

Z^{T+1}=Z_{D},

where Zₜ and Z′ₜ are respectively the drought warning capacity and drought guaranteed capacity of the aggregated reservoir in t^{th} month, Zₜ₊₁ and Z′ₜ₊₁ are respectively the drought warning storage capacity and drought guaranteed storage capacity in (t+1)^{th} month, W_{loss, t} is the amount of water lost by evaporation and leakage of the reservoir in t^{th} month, Dₜ is the inflow of reservoir in t^{th} month in general low-flow years, D′ₜ is the inflow of the reservoir in t^{th} month in the extraordinary low-flow year and Z^{T+1} is the water quantity at the end of design low-flow years.

The drought warning storage capacity and drought guaranteed storage capacity in each month should meet corresponding constraints, which are

$$\{ \begin{matrix}flood season : {Z}_{D} \leq {Z}_{t} \leq {Z}_{L} , {Z}_{D} \leq {Z}_{t}^{′} \leq {Z}_{L} \\ non - flood season : {Z}_{D} \leq {Z}_{t} \leq {Z}_{N} , {Z}_{D} \leq {Z}_{t}^{′} \leq {Z}_{N}\end{matrix} , \\ {Z}_{t} \geq {Z}_{t}^{′} ,$$

where Z_{D} is the dead storage capacity of the aggregated reservoir, Z_{L} is the flood limited storage capacity of the aggregated reservoir and Z_{N} is the beneficial water storage capacity of the aggregated reservoir.

### Embodiment 2

In this embodiment, the implementation process of the calculation method provided by the present disclosure is specifically explained with specific examples. A reservoir B is a series reservoir downstream of reservoir A, and the reservoir A mainly delivers water to reservoir B.

I. Obtaining the characteristic storage capacity of the aggregated and generalized reservoir

Reservoir A and reservoir B are cascade reservoirs and jointly supply water to users such as in cities and irrigation areas. Reservoir A and reservoir B are generalized into one aggregated reservoir and the storage capacity of the aggregated reservoir is a sum of reservoir A and reservoir B. The reservoir design parameters, such as the characteristic storage capacity information of each reservoir are obtained based on the investigated and collected dispatching data of reservoir A and reservoir B, then the cascade reservoirs in series are aggregated and generalized by adopting the characteristic storage capacity superposition method of single reservoir, and the characteristic storage capacity of the aggregated reservoir is obtained, as shown in Table 1.

Characteristic Storage Capacity of the Aggregated Reservoir

| | | | Aggregated |
|---|---|---|---|
| | Reservoir A | Reservoir B | reservoir |
| Dead storage capacity | 0.8 | 1.2 | 2 |
| Beneficial storage capacity | 0.5 | 1.5 | 2 |
| Total storage capacity | 1.3 | 2.7 | 4 |

II. Determining the stages of drought early warning of the aggregated reservoir

Stages of drought early warning of the aggregated reservoir are determined according to the basin precipitation, runoff, user demand and reservoir regulation and storage and the stages of drought early warning of the aggregated reservoir are generally divided into flood seasons (from July to September), non-flood seasons (from October to March) and agricultural irrigation seasons (from April to June).

III. Calculating the water inflow of the aggregated and generalized reservoir

The monthly inflow of the aggregated reservoir in general low-flow years and extraordinary low-flow years are obtained through superimposing separately the monthly inflow of single reservoirs in general low-flow years and extraordinary low-flow years.

The corresponding inflow is obtained through the inflow runoff of reservoir A and reservoir B in general low-flow years and extraordinary low-flow years and series of design low-flow years of the inflow of the aggregated reservoir is obtained by the method of accumulation, as shown in Table 2.

TABLE 2
Water Inflow in General Low-flow years and Extraordinary
Low-flow Years (100 million m³)

| | General low-flow years | | | Extraordinary low-flow years | | |
|---|---|---|---|---|---|---|
| | Reservoir | Reservoir | Aggregated | Reservoir | Reservoir | Aggregated |
| Month | A | B | reservoir | A | B | reservoir |
| July | 0.27 | 0.27 | 0.54 | 0.15 | 0.15 | 0.3 |
| August | 0.22 | 0.22 | 0.44 | 0.33 | 0.33 | 0.66 |
| September | 0.25 | 0.25 | 0.5 | 0.35 | 0.35 | 0.7 |
| October | 0.19 | 0.19 | 0.38 | 0.21 | 0.21 | 0.42 |
| November | 0.18 | 0.18 | 0.36 | 0.2 | 0.2 | 0.4 |
| December | 0.14 | 0.14 | 0.28 | 0.2 | 0.2 | 0.4 |
| January | 0.15 | 0.15 | 0.3 | 0.2 | 0.2 | 0.4 |
| February | 0.2 | 0.18 | 0.38 | 0.2 | 0.2 | 0.4 |
| March | 2.02 | 1 | 3.02 | 1.37 | 0.8 | 2.17 |
| April | 0.57 | 0.17 | 0.74 | 0.21 | 0 | 0.21 |
| May | 0.56 | 0.21 | 0.77 | 0.14 | 0 | 0.14 |
| June | 0.16 | 0.16 | 0.32 | 0.17 | 0.17 | 0.34 |

IV. Calculating the design water supply of the aggregated reservoir

The water supply guarantee targets of reservoir A and reservoir B are determined. The water supply targets of reservoir A are urban domestic water, regional agricultural irrigation water and environmental ecological water and the water supply targets of reservoir B are urban domestic water, industrial water, agricultural irrigation water and ecological water.

The water demand is calculated by combining water quota with socio-economic indicators; the important industrial water demand is determined according to the local actual situation or by a product of an adjustment coefficient determined based on the damage depth requirement and a design water demand; finally, the design water supply of the aggregated reservoir is calculated by superimposing the design water supply of the single reservoirs.

The quantity of water demand of reservoir A is calculated with reference to the data of reservoir A's dispatching plan and dispatching diagram, etc., and water survey statistics method is adopted to focus on the investigation and statistics of water consumption data of urban and rural water supply, enterprise production, agricultural irrigation and environmental ecology. For each industry, the monthly average water consumption is calculated in the general low-flow years group, as the industry's off-stream quantity of water demand in drought years, as shown in Table 3.

TABLE 3
Design Water Supply of Reservoir A
in Drought Years (100 million m³)

| | | Interval | | | |
|---|---|---|---|---|---|
| | Urban | irrigation | | | |
| | water | water | Ecological | | |
| Month | supply | supply | water | Evaporation | Seepage |
| July | 0.0167 | 0.0404 | 0.0750 | 0.0362 | 0.0205 |
| August | 0.0167 | 0.0000 | 0.0750 | 0.0323 | 0.0204 |
| September | 0.0167 | 0.1174 | 0.0750 | 0.0183 | 0.0211 |
| October | 0.0167 | 0.0000 | 0.0750 | 0.0155 | 0.0227 |
| November | 0.0167 | 0.1174 | 0.0750 | 0.0145 | 0.0228 |
| December | 0.0167 | 0.0000 | 0.0750 | 0.0162 | 0.0225 |
| January | 0.0167 | 0.0000 | 0.0750 | 0.0095 | 0.0231 |
| February | 0.0167 | 0.0000 | 0.0750 | 0.0156 | 0.0236 |
| March | 0.0167 | 0.1174 | 0.0750 | 0.0160 | 0.0137 |
| April | 0.0167 | 0.3062 | 0.0750 | 0.0165 | 0.0115 |
| May | 0.0167 | 0.1174 | 0.0750 | 0.0175 | 0.0084 |
| June | 0.0167 | 0.2765 | 0.0750 | 0.0159 | 0.0077 |

As for calculation of quantity of water demand of reservoir B, water supply processes with different warning levels are designed according to water supply demand and guarantee levels of various industries. With reference to the reservoir dispatching plan and dispatching diagram of reservoir B, the water consumption survey and statistics method is adopted to focus on the water consumption data of urban and rural water supply, enterprise production, agricultural irrigation and environmental ecology. For each industry, the monthly average water consumption in the general low-flow year group is calculated as the off-stream quantity of water demand in the drought year of the industry, as shown in Table 4.

TABLE 4
Design Water Supply of Reservoir B
in Drought Years (100 million m³)

| | | Interval | | | |
|---|---|---|---|---|---|
| | Urban | irrigation | | | |
| | water | water | Ecological | | |
| Month | supply | supply | water | Evaporation | Seepage |
| July | 0.0083 | 0.1416 | 0.0912 | 0.0238 | 0.0045 |
| August | 0.0083 | 0.0000 | 0.0912 | 0.0220 | 0.0054 |
| September | 0.0083 | 0.5076 | 0.0912 | 0.0144 | 0.0068 |
| October | 0.0083 | 0.0000 | 0.0912 | 0.0126 | 0.0074 |
| November | 0.0083 | 0.5076 | 0.0912 | 0.0047 | 0.0085 |
| December | 0.0083 | 0.0000 | 0.0912 | 0.0051 | 0.0094 |
| January | 0.0083 | 0.0000 | 0.0912 | 0.0042 | 0.0102 |
| February | 0.0083 | 0.0000 | 0.0912 | 0.0155 | 0.0116 |
| March | 0.0083 | 0.5076 | 0.0912 | 0.0195 | 0.0072 |
| April | 0.0083 | 1.0490 | 0.0912 | 0.0216 | 0.0049 |
| May | 0.0083 | 0.5076 | 0.0912 | 0.0237 | 0.0042 |
| June | 0.0083 | 0.5095 | 0.0912 | 0.0233 | 0.0043 |

The design water supply of the aggregated reservoir is calculated by superimposing the design water supply of the single reservoirs. The design water supply of the aggregated reservoir of reservoir A and reservoir B is the sum of the water supply of the two reservoirs. Then, the design water supply of the aggregated reservoir is shown in Table 5.

TABLE 5
Design water supply of the aggregated reservoirs (100 million m³)

| | Joint | Joint | | | |
|---|---|---|---|---|---|
| | urban | irrigation | | | |
| | water | water | Joint | Joint | Joint |
| Month | supply | supply | ecology | evaporation | seepage |
| July | 0.1583 | 0.0487 | 0.1662 | 0.06 | 0.025 |
| August | 0.0167 | 0.0083 | 0.1662 | 0.0543 | 0.0258 |
| September | 0.5243 | 0.1257 | 0.1662 | 0.0327 | 0.0279 |
| October | 0.0167 | 0.0083 | 0.1662 | 0.0281 | 0.0301 |
| November | 0.5243 | 0.1257 | 0.1662 | 0.0192 | 0.0313 |
| December | 0.0167 | 0.0083 | 0.1662 | 0.0213 | 0.0319 |
| January | 0.0167 | 0.0083 | 0.1662 | 0.0137 | 0.0333 |
| February | 0.0167 | 0.0083 | 0.1662 | 0.0311 | 0.0352 |
| March | 0.5243 | 0.1257 | 0.1662 | 0.0355 | 0.0209 |
| April | 1.0657 | 0.3145 | 0.1662 | 0.0381 | 0.0164 |
| May | 0.5243 | 0.1257 | 0.1662 | 0.0412 | 0.0126 |
| June | 0.5262 | 0.2848 | 0.1662 | 0.0392 | 0.012 |

V. Setting two levels of guarantee coefficients for the aggregated reservoir to limit water supply

According to a drought limited storage capacity of the aggregated reservoir, limiting the water supply to the industries is carried out by setting different water supply guarantee coefficients, so as to achieve drought early warning of different levels. Water supply guarantee coefficients are shown in Table 6.

TABLE 6
Water Supply Guarantee Coefficients
of Different Supply Limit Levels

| | Urban | | Ecological |
|---|---|---|---|
| Levels of Supply | water supply | Irrigation | water supply |
| limit | coefficient | coefficient | coefficient |
| I | 1 | 0.9 | 1 |
| II | 0.5 | 0.5 | 0.3 |

The two-level water supply guarantee coefficient is multiplied by the design water supply of the aggregated reservoir, and the water supply in the general low-flow years and the extraordinary low-flow years are obtained as show in Tables 7 and 8, so as to calculate the drought warning storage capacity and drought guaranteed storage capacity.

TABLE 7
Design water supply (100 million m³) of the aggregated
reservoir in general low-flow years (75%)

| | Joint | Joint | | | |
|---|---|---|---|---|---|
| | urban | irrigation | | | |
| | water | water | Joint | Joint | Joint |
| Month | supply | supply | ecology | evaporation | seepage |
| July | 0.025 | 0.164 | 0.166 | 0.060 | 0.025 |
| August | 0.025 | 0.000 | 0.166 | 0.054 | 0.026 |
| September | 0.025 | 0.563 | 0.166 | 0.033 | 0.028 |
| October | 0.025 | 0.000 | 0.166 | 0.028 | 0.030 |
| November | 0.025 | 0.563 | 0.166 | 0.019 | 0.031 |
| December | 0.025 | 0.000 | 0.166 | 0.021 | 0.032 |
| January | 0.025 | 0.000 | 0.166 | 0.014 | 0.033 |
| February | 0.025 | 0.000 | 0.166 | 0.031 | 0.035 |
| March | 0.025 | 0.563 | 0.166 | 0.036 | 0.021 |
| April | 0.025 | 1.220 | 0.166 | 0.038 | 0.016 |
| May | 0.025 | 0.563 | 0.166 | 0.041 | 0.013 |
| June | 0.025 | 0.707 | 0.166 | 0.039 | 0.012 |

TABLE 8
Design Water Supply (100 million m³) of the aggregated
reservoir in Extraordinary low-flow years (95%)

| | Joint | Joint | | | |
|---|---|---|---|---|---|
| | urban | irrigation | | | |
| | water | water | Joint | Joint | Joint |
| Month | supply | supply | ecology | evaporation | seepage |
| July | 0.013 | 0.091 | 0.050 | 0.060 | 0.025 |
| August | 0.013 | 0.000 | 0.050 | 0.054 | 0.026 |
| September | 0.013 | 0.313 | 0.050 | 0.033 | 0.028 |
| October | 0.013 | 0.000 | 0.050 | 0.028 | 0.030 |
| November | 0.013 | 0.313 | 0.050 | 0.019 | 0.031 |
| December | 0.013 | 0.000 | 0.050 | 0.021 | 0.032 |
| January | 0.013 | 0.000 | 0.050 | 0.014 | 0.033 |
| February | 0.013 | 0.000 | 0.050 | 0.031 | 0.035 |
| March | 0.013 | 0.313 | 0.050 | 0.036 | 0.021 |
| April | 0.013 | 0.678 | 0.050 | 0.038 | 0.016 |
| May | 0.013 | 0.313 | 0.050 | 0.041 | 0.013 |
| June | 0.013 | 0.393 | 0.050 | 0.039 | 0.012 |

VI. Calculating the drought limited storage capacity of the aggregated reservoir

For the aggregated reservoir, the reverse order calculation of different inflow frequencies is carried out, and the drought limited storage capacity of the aggregated reservoir is calculated shown in Table 9 and taken as drought limited storage capacity of the cascade reservoirs.

TABLE 9
Drought Limited Storage Capacity of the Aggregated Reservoir

| | | Monthly | Monthly | Staged | Staged |
|---|---|---|---|---|---|
| | | drought | drought | drought | drought |
| | | warning | guaranteed | warning | guaranteed |
| | | storage | storage | storage | storage |
| Stages | Month | capacity | capacity | capacity | capacity |
| Flood | July | 2.36 | 2.00 | 2.63 | 2.00 |
| season | August | 2.46 | 2.00 | 2.63 | 2.00 |
| | September | 2.63 | 2.00 | 2.63 | 2.00 |
| Non- | October | 2.31 | 2.00 | 2.31 | 2.03 |
| flood | November | 2.44 | 2.03 | 2.31 | 2.03 |
| season | December | 2.00 | 2.00 | 2.31 | 2.03 |
| | January | 2.00 | 2.00 | 2.31 | 2.03 |
| | February | 2.00 | 2.00 | 2.31 | 2.03 |
| | March | 2.00 | 2.00 | 2.31 | 2.03 |
| Agricultural | April | 3.39 | 3.04 | 3.39 | 3.04 |
| irrigation | May | 2.67 | 2.46 | 3.39 | 3.04 |
| season | June | 2.63 | 2.17 | 3.39 | 3.04 |

By adopting the above disclosed technical scheme, the following beneficial effects of the present disclosure are realized:

according to the method for calculating grading and staged drought limited storage capacity of cascade reservoirs, after the water supply guarantee target of cascade reservoirs is integrated, the inflow water of the single reservoirs in general low-flow years and extraordinary low-flow years is accumulated, and the drought-resistant index of the drought limited storage capacity of cascade reservoirs is obtained by the recursion method in reverse order, which provides direct support for scientific and orderly development of drought-resistant early warning work. Therefore, the drought limited storage capacity of cascade reservoirs is determined by zoning, classifying and grading, so as to meet the guarantee demand of drought-resistant water sources and provide reference for the optimal dispatching of water conservancy projects. As for drought storage capacity of reservoir group, the cascade reservoirs can be generalized into the aggregated reservoir according to the operation principle of the reservoir group, and the water supply demand and guarantee level of each user of the aggregated reservoir can be determined. At the same time, combined with the priority and guarantee rates of production, domestic, and ecological water demand in drought periods, the determination method for classifying, staging and grading drought limited storage capacity index is studied, and the drought limited storage capacity is formulated according to the characteristics of different regions, which provides scientific basis and technical support for drought prevention command and decision.

The above are only the preferred embodiments of the present disclosure. It should be pointed out that for those of ordinary skill in the technical field, without departing from the principle of the present disclosure, several improvements and embellishments may be made. These improvements and embellishments should also be regarded as the protection scope of the present disclosure.

What is claimed is:

1. A method for calculating grading and staged drought limited storage capacity of cascade reservoirs in different stages of drought, comprising:
S1: analyzing a characteristic storage capacity of multiple single reservoirs, and aggregating and generalizing the cascade reservoirs based on multiple reservoirs in series to obtain the characteristic storage capacity of an aggregated and generalized reservoir;
S2: determining stages of drought early warning of the aggregated reservoir according to a basin precipitation, a runoff, a user demand and a reservoir regulation and storage;
S3: analyzing a water inflow of single reservoirs, and calculating the water inflow of the aggregated and generalized reservoir by superimposing the water inflow of the single reservoirs;
S4: analyzing a water supply guarantee target of the aggregated reservoir, and calculating a design water supply of the aggregated reservoir by superimposing the design water supply of the single reservoirs;
S5: grading a drought limited storage capacity into two levels according to actual drought early warning demand, a drought warning storage capacity and a drought guaranteed storage capacity, and setting water supply coefficients for graded drought limited storage capacities to realize drought early warning and water supply limit; and
S6: comprehensively calculating drought limited storage capacities of the aggregated reservoir based on a reservoir dispatching technology of recursion in a reverse order as drought limited storage capacity of the cascade reservoir;
wherein S4 specifically comprises: calculating the design water supply of the aggregated reservoir superimposing the design water supply of the single reservoirs according to following formula:
W_{T}=Σⱼ₌₁ⁿ{W_{s,j}+W_{g,j}+W_{ir,j}},
wherein W_{T} is the design water supply of the generalized cascade reservoir, and W_{s,j}, W_{g,j}, W_{ir,j} are a domestic design water supply, an industrial design water supply and an agricultural design water supply of the j^{th} reservoir in t^{th} month;
wherein S5 comprises: aiming at the drought limited storage capacities of the aggregated reservoir, limiting the water supply to industries by setting different water supply guarantee coefficients, so as to achieve drought early warning of different levels; and calculation formulae are
Wₜ=Σⱼ₌₁ⁿ{W_{s,j}+W_{g,j}+a×W_{ir,j}},
Wₜ′=Σⱼ₌₁ⁿ{W_{s,j}+b×W_{g,j}+a×W_{ir,j}},
wherein Wₜ is the water supply of the aggregated reservoir after the level-I supply limit of an early warning object in t^{th} month; Wₜ′ is the water supply of the aggregated reservoir after level-II supply limit of the early warning object in t^{th} month; a and b are adjustment coefficients respectively, a represents a ratio of a minimum agricultural water consumption to the design water supply, and b represents a ratio of a minimum industrial water consumption to the design water supply.

2. The method according to claim 1, wherein S1 comprises:
obtaining the characteristic storage capacity information of every reservoir based on an investigated and collected dispatching data of multiple reservoirs, and then aggregating and generalizing series cascade reservoirs by using the characteristic storage capacity superposition method of single reservoirs, to obtain the characteristic storage capacity of the aggregated reservoir; and calculation formulae are
Z_{D}=Σⱼ₌₁ⁿZ′_{Dj},
Z_{L}=Σⱼ₌₁ⁿZ′_{Lj},
Z_{N}=Σⱼ₌₁ⁿZ′_{Nj},
wherein Z′_{Dj} is a dead storage capacity of the j^{th} reservoir, Z′_{Lj} is a flood limited storage capacity of the j^{th} reservoir, Z′_{Nj} is a beneficial storage capacity of the j^{th} reservoir and Z_{D}, Z_{L} and Z_{N} are the dead storage capacity, the flood limited storage capacity and the beneficial storage capacity of the aggregated reservoir respectively.

3. The method according to claim 2, wherein S2 comprises:
determining the stages of drought early warning of the aggregated reservoir according to the basin precipitation, runoff, user demand and reservoir regulation and storage, and generally dividing the stages of drought early warning of the aggregated reservoir into flood seasons, non-flood seasons and agricultural irrigation seasons.

4. The method according to claim 3, wherein S3 comprises:
superposing the monthly inflow of single reservoirs in general low-flow years and extraordinary low-flow years respectively to obtain the monthly inflow of the aggregated reservoir in the general low-flow years and the extraordinary low-flow years; and calculation formulae are
Dᵢ=Σⱼ₌₁ⁿQⱼᵢ,
D′ᵢ=Σⱼ₌₁ⁿQ′ⱼᵢ,
wherein Qⱼᵢ is inflow water of the j^{th} reservoir in the i^{th} month in the general low-flow years, Q′ⱼᵢ is inflow water of the j^{th} reservoir in the i^{th} month in the extraordinary low-flow years, Dᵢ is the inflow water of the aggregated reservoir in the i^{th} month in the general low-flow years; D′ᵢ is the inflow of the aggregated reservoir in the i^{th} month in the extraordinary low-flow years.

5. The method according to claim 1, wherein S6 comprises:
taking inflow runoff quantity in the design low-flow years and a process of guaranteeing water supply in different levels as inputs, assuming that water quantity at the end of a water supply season just reaches the dead storage capacity of the reservoir, out of consideration of continuous drought process, and obtaining the water quantity at the beginning of each month under different drought levels of the aggregated reservoir by means of recursion in the reverse order according to a regulation principle of reservoir benefit; selecting a highest water quantity at a beginning of each month in each stage as a drought warning storage capacity or a drought guaranteed storage capacity in each stage, a drought warning storage capacity or a drought guaranteed storage capacity of the cascade reservoirs; and the drought warning storage capacity and drought guaranteed storage capacity in each month are calculated as follows:
Zₜ=Wₜ+W_{loss,t}−Dₜ+Zₜ₊₁,
Z′ₜ=W′ₜ+W_{loss,t}−D′ₜ+Z′ₜ₊₁,
Z^{T+1}=Z_{D},
wherein Zₜ and Z′ₜ are respectively the drought warning capacity and drought guaranteed capacity of the aggregated reservoir in t^{th} month, Zₜ₊₁ and Z′ₜ₊₁ are respectively the drought warning storage capacity and drought guaranteed storage capacity in (t+1)^{th} month, W_{loss, t} is the amount of water lost by evaporation and leakage of the reservoir in t^{th} month, Dₜ is the inflow of reservoir in t^{th} month in general low-flow years, D′ₜ is the inflow of the reservoir in t^{th} month in the extraordinary low-flow year and Z^{T+1} is the water quantity at the end of design low-flow years; Wₜ is the water supply of reservoir in t^{th} month in general low-flow years; W′ₜ is the water supply of the reservoir in t^{th} month in the extraordinary low-flow years.

6. The method according to claim 5, wherein the drought warning storage capacity and drought guaranteed storage capacity in each month meet corresponding constraints below:
$$\{ \begin{matrix}flood season : {Z}_{D} \leq {Z}_{t} \leq {Z}_{L} , {Z}_{D} \leq {Z}_{t}^{′} \leq {Z}_{L} \\ non - flood season : {Z}_{D} \leq {Z}_{t} \leq {Z}_{N} , {Z}_{D} \leq {Z}_{t}^{′} \leq {Z}_{N}\end{matrix} , \\ {Z}_{t} \geq {Z}_{t}^{′} ,$$
wherein Z_{D} is the dead storage capacity of the aggregated reservoir, Z_{L} is the flood limited storage capacity of the aggregated reservoir, and Z_{N} is the beneficial water storage capacity of the aggregated reservoir.
